(19) United States
(12) Patent Application Publication
(10) Pub. No.: US 2005/0074605 A1
(43) Pub. Date: Apr. 7, 2005

(54) Thermoplastic multi-layer laminates

(76) Inventor: Purushottam Das Agrawal, Akron, OH (US)

Correspondence Address: WALKER & JOCKE, L.P.A., 231 SOUTH BROADWAY STREET, MEDINA, OH, 44256, US

(21) Appl. No.: 10/677,543

(22) Filed: Oct. 1, 2003

(51) Int. Cl. B29C 47/06; B32B 27/30; B32B 27/40; B32B 27/32; B32B 27/08; B32B 31/30

(52) U.S. Cl. 428/354; 156/244.11; 428/422; 428/423.1; 428/523; 428/522

(57) ABSTRACT

Flexible materials substantially resistant to the growth of microorganisms in aqueous systems comprising fluoropolymers such as TEFLON bonded to polymeric substrates derived from polymeric blends comprising thermoplastic polyurethanes, olefin copolymers, maleic anhydride-olefin copolymers, olefin-vinyl acetate copolymers and phenolic resins. The fluoropolymers are bonded e.g. laminated onto the polymeric substrates e.g. by coextrusion and used in the preparation of tubes, hoses, covers and liners to inhibit microbial growth on surfaces submerged in water.

### FIELD OF THE INVENTION

This invention relates to flexible thermoplastic multi-layer laminates, to the process of preparing same, and to the use of said laminates to inhibit bacterial adhesion to surfaces submerged in aqueous systems such as boat hulls, water-tank liners, hoses, and the like.

### BACKGROUND OF THE INVENTION

Microorganisms adhere to a variety of surfaces, particularly surfaces submerged in aqueous systems which provides an environment that promotes microbial growth. More specifically, microorganisms are known to adhere to hulls of ships, water tanks or towers, heat-exchangers, and various other marine structures. The adherence of these microorganisms to the submerged surfaces e.g. ship hulls fouls the surfaces causing deterioration.

Biofouling is a persistent nuisance in a variety of aqueous systems. Biofouling, both microbiological and macrobiological fouling, is caused by the buildup of microorganisms, extracellular substances, dirt and debris that becomes trapped in the biomass. The specific organisms involved include bacteria, fungi, algae, protozoa, and macro organisms such as barnacles, and small mollusks like Zebra Mussels.

To control the biofauling in these aqueous systems including submerged surfaces such as ship hulls is to prevent bacterial adhesion to the surfaces. This can be accomplished, in accordance with this invention, by using a fluoropolymer bonded to a polymeric substrate and used as a liner or cover on the submerged surface. Fluorine-containing polymers are an important class of polymers that include the fluoroelastomers and fluoroplastics. Among this broad class of polymer are polymers of high-thermal stability, polymers of extreme toughness, and polymers exhibiting usefulness along a spectrum of temperatures. These polymers are substantially insoluble in a variety of organic solvents; see, for example, the Textbook of Polymer Science, 3^{rd} ed., John Wiley & Sons, New York (1984).

More specifically, the fluoroplastics, particularly polychlorotrifluoroethylene, polytetrafluoroethylene, copolymers of tetrafluoroethylene and hexafluoropropylene, have numerous applications. Fluoroplastics are useful, for example, as liners, covers, sheet materials, and the like in various aqueous and non-aqueous systems; see, for example, “Organic Fluorine Compounds,” Kirk-Othmer, Encyclopedia of Chemical Technology, Vol. 11.

### SUMMARY OF THE INVENTION

This invention relates to flexible materials or articles of manufacture substantially resistant to microbial growth or microorganisms such as fungi, algae, barnacles, bacteria and the like. The flexible materials or articles of this invention comprise fluoropolymers bonded to polymeric substrates e.g. laminates derived from polymeric blends comprising from about 10 to 60 parts by weight of thermoplastic polyurethanes, 15 to 60 parts by weight of olefinic copolymers, 1.0 to 15 parts by weight of maleic anhydride-olefinic copolymers, 15 to 35 parts by weight of olefin-vinyl acetate copolymers, and 0.0 to 2.0 parts by weight of a phenolic resin.

Accordingly, it is an object of this invention to provide fluoropolymer laminates for use on surfaces submerged in water such as boat hulls to inhibit or prevent the growth of microorganisms.

It is another object of this invention to provide fluoropolymer laminates as a liner for aqueous systems such as water tanks to prevent the growth of bacteria and other organisms.

It is a further object of this invention to provide fluoropolymer laminates for use in the preparation of flexible hoses or tubes for use in aqueous systems to prevent the growth of bacteria and other organisms.

It is still a further object of this invention to provide fluoropolymers laminated directly onto non-fluoropolymer substrates, and to provide a method for preparing said laminates.

These and other objects of this invention will become more apparent from a further and more detailed description of the invention.

### DETAILED DESCRIPTION OF THE INVENTION

This invention relates to flexible materials substantially resistant to microorganisms, and to the method of preparing laminates of fluoropolymers with improved bond strength between the fluoropolymer layer and a polymeric substrate without the use of a tie layer between the substrate and the fluoropolymer. The flexible materials of this invention are substantially resistant to microorganisms such as algae and bacteria and comprise a meltable fluoropolymer bonded e.g. laminated to a polymeric substrate derived from a novel polymeric blend comprising from about 10 to 60 and preferably 45 to 55 parts by weight of a thermoplastic polyurethane, 15 to 60 and preferable 18 to 22 parts by weight of an olefinic copolymer such as an ethylene-octene copolymer, 1.0 to 15 and preferably 2.0 to 8.0 parts by weight of a maleic anhydride-olefin copolymer, 15 to 35 and preferably 20 to 30 parts by weight of an olefin-vinyl acetate copolymer, and 0.0 to 2.0 and preferably 0.5 to 1.5 parts by weight of a phenolic resin.

The preferred fluoropolymers of this invention comprise the fluoropolymers available as RP-4020, RP-4040 and RP-5000, from Daikin America, Inc. under the trademark NEOFLON (EFEP-RP Series). These fluoropolymers have excellent physical and chemical properties having, for example, very low melting temperature characteristics in comparison to conventional thermoplastic. Typical properties of these fluoropolymers are shown in Table 1.

TABLE I

| | | | | |
|---|---|---|---|---|
| Specific Gravity | — | ASTM D792 | 1.74 | 1.74 |
| Melting Point | ° C. | DSC | 160 | 160 |
| MFR (265° C., 5 kg) | G/10 min | ASTM D1238 | 25˜50 | 3˜8 |
| Tensile Strength | Mpa | ASTM D638 | 45 | 55 |
| Elongation | % | ASTM D638 | 500 | 450 |
| Flexural Modulus | Mpa | ASTM D790 | 1300 | n/a |
| Light Transmission | % | 250 mm | 87 | n/a |
| (100 micron film) | | | | |

However, since fluoropolymers are expensive, these materials are used in the form of a composite or multi-layer structure which reduces the amount of fluoropolymer required to produce the structure. In the manufacture of these multi-layer structures, e.g. laminates, the fluoropolymer is bonded to a substrate. Thus, the fluoropolymer and the substrate are combined, taking advantage of the useful properties of each material; i.e., the fluoropolymer layer can be a thin, flexible layer which provides resistance to microorganism attack and/or barrier properties, while the substrate provides the desired strength and flexibility, at a substantial cost reduction.

With regard to a fluoropolymer constituting a layer of the coextruded laminate, the selected fluoropolymers are melt extrudable, as indicated by having a melt viscosity in the range of 0.5×10³ to 60×10³. The preferred fluoropolymers are copolymers of ethylene with perhalogenated monomers such as tetrafluoroethylene (TFE) and chlorotrifluoroethylene (CTFE), which are referred to as ETFE and ECTFE, respectively. In the example of ETFE, minor amounts of an additional monomer can be used to improve the properties such as reduced high-temperature brittleness. The perfluoro polymers such as perfluoro (ethyl vinyl ether), perfluorobutyl ethylene (PFBE), and hexafluoroisobutylene (HFIB) are some of the preferred comonomers. Of all the fluoropolymers, the most preferred fluoropolymer is (TEFLON), a fully fluorinated copolymer of hexafluoropropylene and tetrafluoroethylene.

The fluoropolymers and the polymeric substrates of this invention can be coextruded by conventional methods, provided the extrusion is carried out under conditions that no degradation of the lower melting substrate occurs. The coextruded laminate consist of two layers, one of the fluoropolymer layer and the other the polymeric substrate layer of this invention bonded together without any tie layer. The polymeric substrate provides strength to the overall sheets of laminate. When the laminate is in the form of tubing or hoses, the interior layer or inner surface of the tubing is usually the fluoropolymer layer. For example, a coextruded tubing is about 0.270 inches (6.86 mm) in the outer diameter and has a wall thickness of about 0.055 inch (1.4 mm) while the fluoropolymer inner layer is about 0.006 inch (0.15 mm) thick.

Generally, the fluoropolymer can be extruded using a 1.0-inch (2.54-cm) Davis extruder equipped with an extrusion screw while operating at a barrel pressure of 410 psig (2.93 MPa) and at a melt temperature of 616° F. (324° C.) entering the coextrusion crosshead to form the layer of coextruded laminate. The polymeric blend is extruded using a 1.5-in Davis extruder equipped with a screw and operating at a barrel pressure of 600 psig at a melt temperature of about 360° F. entering the coextrusion crosshead to form the substrate layer of the coextruded laminate.

In preparing the laminated sheets or tubes of this invention, the thermoplastic polyurethane is present in the polymeric blend in the preferred amount ranging from about 45 to 55 parts by weight. The preferred thermoplastic polyurethanes are thermoplastic polyurethanes obtained from Dow Chemical Co. under the trademark, PELLETHANE 2102-80A. Other polyurethanes (TPU) useful in the polymeric blend of this invention are the modified polycaprolactone-based polyester-based, and polyether-based thermoplastic polyurethanes. The polyether-based thermoplastic polyurethanes can be obtained from the Noveon Chemical Co. under the trademark ESTANE. These polyurethanes have the properties shown in Table 2.

TABLE 2

| PROCESSING | Extrusion | Temperature 185-195° C. | |
|---|---|---|---|
| | Injection Molding | Temperature 175-185° C. | |
| MECHANICAL | | | |
| PROPERTIES | TEST METHOD | UNIT | VALUE* |
| Hardness | DIN 53505 | shore A/D | 88/1.24 |
| Density | DIN 53479 | g/cm³ | |
| Tensile strength | DIN 53504 | MPa | 31 |
| Elongation | | % | 655 |
| Tensile Stress at | | | |
| 50% Elongation | | MPa | 4.9 |
| 100% Elongation | | MPa | 5.5 |
| 300% Elongation | | MPa | 7.2 |
| Tear Resistance | DIN 53515 | kN/m | 45 |
| Abrasion loss | DIN 53516 | mm3 | 150 |
| Rebound resilience | DIN 53512 | % | 35 |
| Brittle Point | DIN 53546 | ° C. | −70 |
| Oxygen Index | ASTM D26603 | % | 30 |
| Vertical burn test | UL 94 | | V0 |

Other thermoplastic polyurethanes (TPU) used in the blends of the present invention are commercially available; see, Rubber Technology, 2^{nd} edition, edited by Maurice Morton (1973), Chapter 17, Urethane Elastomers. Thermoplastic polyurethanes (TPU) are derived from the reaction of polyester or polyether polyols with diisocyanates and also from the reaction of components with chain-extending agents such as low molecular weight polyols, preferably diols, or with diamines to form urea linkages. Thermoplastic polyurethanes are generally composed of soft segments, for example polyether or polyester polyols, and hard segments, usually derived from the reaction of the low molecular weight diols and diisocyanates. While a thermoplastic polyurethane with no hard segments can be used, those most useful will contain both soft and hard segments. The processes for making TPU are well known and include single or multiple step polymerizations. In a single step polymerization, the diisocyanate, polyol and chain extending agent are combined and reacted, whereas in a multiple step process the polyol is first reacted with the diisocyanate to produce a prepolymer which is subsequently reacted with the chain extender to build molecular weight.

The olefin copolymers are present in the polymeric blends of this invention in a preferred amount ranging from about 18 to 22 parts by weight. The preferred olefin copolymers are the ethylene-octene copolymers obtained from Exxon Mobil Chemicals under the trademark EXXPOL (EXACT 0201). The other olefinic polymers used in preparing these polymeric blends include ethylene copolymerized with various monomers such as the C₂-C₈ alpha olefins including propylene, butene-1,1-pentene, 4-methyl pentene-1, hexene-1 and octene-1.

The maleic anhydride-olefin copolymers are present in the polymeric blend in a preferred amount ranging from about 2 to 8 parts by weight. The most preferred maleic-anhydride-ethylene copolymers are available from Exxon-Mobil under the trademark EXXELOR. EXXELOR-VA 1840 are maleic anhydride functionalized elastomeric ethylene copolymers. Typical properties of VA 1840 copolymer are shown in Table 3.

TABLE 3

| | Exxon Mobile Test | | Exxelor |
|---|---|---|---|
| Property | Method (based on) | Unit | VA 1840 |
| Maleic anhydride | FTIR EPK-04 QT-02 | | Medium (*) |
| graft level | | | |
| Melt flow rate index | ASTM D 1238 | g/10 min | 8.0 |
| (5 kg/230° C.) | | | |
| Density | DIN 53479 | g/cm3 | 0.88 |
| Glass transition | DSC | ° C. | −47 |
| temperature (Tg) | | | |
| Volatiles | AM-S 350.03 | % | 0.15 max. |
| Color | ASTM E 313-96 | Yellowness | 25 max |
| | | Index Pellet | |

Other maleic anhydride-olefinic copolymers in the polymeric blend are available as EXXELOR-VA 1803 from the Exxon Mobile Co. Exxelor VA 1803 is a high flow, amorphous ethylene copolymer functionalized with maleic anhydride by reactive extrusion. Its fully saturated backbone results in outstanding thermal and oxidative stability leading to enhanced weatherability. Moreover, its amorphous nature exhibits impact resistance at very low temperatures in blends with other polymer systems.

The ethylene-vinyl acetate copolymers are present in the polymeric blend in preferred amounts ranging from about 20 to 30 parts by weight. These copolymers are available from Exxon Mobil under the trademark ESCORENE. Escorene LD 783 is a 33% by weight vinyl acetate copolymer having the properties shown in Table 4.

TABLE 4

| | | | Typical |
|---|---|---|---|
| | Test Based On | Units (SI) | Value¹ |
| Resin Properties | | | |
| Melt Index | Exxon Mobile Method | g/10 min | 43 |
| Vinyl Acetate | Exxon Mobile Method | wt % | 33 |
| Density | Exxon Mobile Method | g/cm³ | 0.956 |
| Peak Melting | Exxon Mobile Method | ° F. (° C.) | 142 (61) |
| Temperature | | | |
| Bulk Density | ASTM D-1895 (B) | lb/ft³ (kg/m³) | 36 (577) |
| Physical Properties² | | | |
| Softening Point, | Exxon Mobile Method | ° F. (° C.) | 221 (105) |
| R&B | | | |
| Tensile Strength³ @ | ASTM D-638 | psi (MPa) | 440 (3.0) |
| Break | | | |
| Elongation³ @ | ASTM D-683 | % | 1050 |
| Break | | | |

¹Values are typical and should not be interpreted as specifications.
²Physical properties were determined on compression molded specimens.
³Tensile testing was performed on Type IV specimens.

Generally, the ethylene-vinyl acetate copolymers (EVA) in the polymeric blend have a vinyl acetate percentage by weight relative to the ethylene in the range of 15-40 percent by weight. The term “ethylene-vinyl acetate copolymer” includes both the dipolymers and the terpolymers of ethylene with vinyl acetate and with carbon monoxide. Most commercial EVA dipolymers contain about 2-55 percent by weight of vinyl acetate. Terpolymers of ethylene with vinyl acetate and with carbon monoxide may contain about 1840 percent by weight of vinyl acetate and 2-12 percent by weight of carbon monoxide. Polymers of ethylene with vinyl acetate are available from the E.I. DuPont de Nemours and Company, under the trademark Elvax®.

The phenolic resin is present in the polymeric blend in the preferred amounts ranging from about 0.5 to 1.5 parts by weight. These phenolic resins are available from the Schenectady International as SP-1045. The properties of these resins are given in Table 5. SP-1045 Resin is a heat reactive octylphenol-formaldehyde resin which contains methylol groups. It was specifically designed for the cure of isobutylene-isoprene (Butyl) rubber by the resin cure system. The octyl group makes SP-1045 Resin compatible with various elastomers.

TABLE 5
SPECIFICATIONS

| Property | Min. | Max. | Test Method |
|---|---|---|---|
| Melting Point, Capillary, (° F.) | 140 | 150 | T06M01.01 |
| Softening Point, B&R, (° C.) | 80 | 95 | T06M02.01 |
| Methylol Content, (%) | 8 | 11 | T17M01.02 |
| Color, Gardner, 64% in Toluene | 1 | 6 | T04M01.03 |

Other phenolic resins useful in the polymeric blend include the Novalac resins. Novalac resins are described in the Encyclopedia of Polymer Science and Engineering, Volume 11, pages 45-95 (1985). Thermoplastic novolac resins are produced when a less than stoichiometric amount of formaldehyde is reacted with phenol in an acidic solution. In general, novolacs do not contain hydroxymethyl groups and will not crosslink simply by heating. Examples of the novolac resins useful include, but are not limited to, phenol-formaldehyde, resorcinol-formaldehyde, butyl phenol-formaldehyde, p-ethyl phenol-formaldehyde, hexyl phenol-formaldehyde, p-propyl phenol-formaldehyde, pentyl phenol-formaldehyde, p-octyl phenol-formaldehyde, p-heptyl phenol-formaldehyde, p-nonlyl phenol-formaldehyde, bisphenol-A-formaldehyde, hydroxynaphthalene formaldehyde and the alkyl (such as t-butyl) phenol modified esters of rosin. The various novolacs resins differ in their R substituted group, melting points, viscosities and other physical properties.

The polymeric blends describe herein are bonded or laminated e.g. coextruded onto a fluoropolymer such as TEFLON, and are particularly useful in providing sheeting or lining for application to various surfaces that are submerged in aqueous systems or water. To avoid microbial growth on a surface, the polymeric blend side of the laminate is attached to the surface e.g. a boat hull with the fluoropolymer being exposed to the water. This can be accomplished, for example, by using a double-sided pressure-sensitive tape adhering to the polymeric blend layer of the laminate allowing the fluoropolymer to be exposed to the aqueous system or water to inhibit any microbial growth.

Microorganisms will not adhere to a fluoropolymer surface such as polytetra fluoroethylene or TEFLON. The double-sided pressure sensitive tapes are commercially available. More specifically, the double-sided pressure-sensitive adhesive tapes have an elastomeric backing layer, wherein, for example, the substance of the backing layer consists of natural rubber or a mixture of natural rubber and at least one synthetic rubber. An essential constituent of the backing is polyfunctional crosslinker, the pressure-sensitive adhesive is applied to both sides of the backing layer, and between backing layer and pressure-sensitive adhesive there is an interlayer.

The following is an example of the composition, and the method of preparing the polymeric blend and the laminating of said blend with a fluoropolymer.

### EXAMPLE 1

The fluoropolymer (RP 4020) was extruded under the following conditions:

| Z-1 (Hopper) | Z-2 | Z-3 | Z-4 | Adapter |
|---|---|---|---|---|
| 170° C. | 185° C. | 210° C. | 220° C. | 225° C. |

Screw 0.50 mm, 24:1 L/D Compression ratio 2.5 to 1.0
Screw rpm—30
Sheet width—250 mm (10″)
Sheet thickness—0.1 mm (0.004″).

The polymeric blend (TPU) comprises:

| Parts by weight | |
|---|---|
| 50 | polycaprolactone-based thermoplastic polyurethane, |
| 20 | ethylene-octene copolymer |
| 5 | maleic anhydride-ethylene copolymer |
| 24 | ethylene-vinyl acetate copolymer |
| 1.0 | phenolic resin |

The polymeric blend materials in Example 1 were tumble blended on a two (2) inch extruder into a sheet die at a melt temperature of 360° F. The fluoropolymer was laminated onto the polymeric blend (TPU blend). The laminate had excellent adhesion, and a peel strength greater than 25 psi.

Further modification of this invention will occur to one skilled in the art, and such modifications are deemed to be within the scope of the invention as set forth in the appended claims.

1. A flexible material substantially resistant to microorganisms comprising a meltable fluoropolymer bonded to a polymeric substrate; said substrate derived from a polymeric blend comprising from about 10 to 60 parts by weight of a thermoplastic polyurethane, 15 to 60 parts by weight of an olefinic copolymer, 1.0 to 15 parts by weight of a maleic anhydride-olefin copolymer, 15 to 35 parts by weight of an olefin-vinyl acetate copolymer, and 0.0 to 2.0 parts by weight of a phenolic resin.

2. The flexible material of claim 1 wherein the polyurethane is a polycaprolactone-based thermoplastic polyurethane.

3. The flexible material of claim 1 wherein the polyurethane is an ether-based thermoplastic polyurethane.

4. The flexible material of claim 1 wherein the polyurethane is an ester-based thermoplastic polyurethane.

5. The flexible material of claim 1 wherein the fluoropolymer is polytetrafluoro-ethylene.

6. The flexible material of claim 5 wherein the fluoropolymer is laminated onto the polymeric substrate.

7. The flexible material of claim 1 wherein the fluoropolymer is polytetrafluoro-ethylene laminated to the polymeric substrate; said substrate having adhering thereto a two-sided adhesive tape.

8. The flexible material of claim 7 wherein the polymeric substrate is derived from a polymeric blend having 45 to 55 parts by weight of a polycaprolactone-based thermoplastic polyurethane.

9. The flexible material of claim 1 wherein the polymeric blend comprises 45 to 55 parts by weight of the thermoplastic polyurethane, 18 to 22 parts by weight of the olefinic copolymer, 2.0 to 8.0 parts by weight of the maleic anhydride-olefin copolymer, 20 to 30 parts by weight of the olefin-vinyl acetate copolymer and 0.5 to 1.5 parts by weight of the phenolic resin.

10. The flexible material of claim 9 wherein the polyurethane is a polycaprolactone-based thermoplastic polyurethane.

11. The flexible material of claim 10 wherein the polyurethane is an ether-based thermoplastic polyurethane.

12. The flexible material of claim 9 wherein the fluoropolymer is polytetrafluoro-ethylene.

13. The flexible material of claim 12 wherein the fluoropolymer is laminated onto the polymeric substrate.

14. The flexible material of claim 13 wherein the polyurethane is a polycaprolactone-based thermoplastic polyurethane.

15. A process of preparing a flexible material substantially resistant to microorganisms which comprises laminating a meltable fluoropolymer onto a polymeric substrate; said substrate derived from a polymeric blend comprising from about 10 to 60 parts by weight of a thermoplastic polyurethane, 15 to 60 parts by weight of an olefin copolymer, 1.0 to 15 parts by weight of a maleic anhydride-olefin copolymer, 15 to 35 parts by weight of an olefin-vinyl acetate copolymer, and 0.0 to 2.0 parts by weight of a phenolic resin.

16. The process of claim 15 wherein the fluoropolymer is polytetrafluoroethylene.

17. The process of claim 16 wherein the polyurethane in the polymeric blend is a polycaprolactone-based thermoplastic polyurethane.

18. The process of claim 16 wherein the fluoropolymer is coextruded with the polymeric blend to form the laminate.

19. The process of claim 18 wherein the fluoropolymer is polytetrafluoro-ethylene.

20. The flexible material obtained by the process of claim 19.
